(19) United States
(12) Patent Application Publication
(10) Pub. No.: US 2007/0007735 A1
(43) Pub. Date: Jan. 11, 2007

(54) Freely rotatable binding for board sports with internal resilience and safety lock

(76) Inventor: Daniel M. Stefanic, Santa Monica, CA (US)

Correspondence Address: LAW OFFICES OF DAVID L. HOFFMAN, 27023 MCBEAN PKWY, SUITE 422, VALENCIA, CA, 91355, US

(21) Appl. No.: 11/180,052

(22) Filed: Jul. 11, 2005

(51) Int. Cl. B62B 13/00

(52) U.S. Cl. 280/14.22

(57) ABSTRACT

A binding for a snowboard or wakeboard is rotatable in a horizontal plane along the board, during use. Preferably, the binding is biased to a preset or original or home position. The biasing force is adjustable and generally is set in a range that allows movement during actual use of the board, requiring more than casual effort to change the angle but less than extreme effort to change the angle. In one embodiment, there are two arcuate channels in the bottom of a binding plate. In each channel there is a spring assembly having a central block fixed to a circular bottom plate. The block has a spring on each side, which springs are also in the channel. As a user rotates his foot in the binding, the binding plate rotates on the circular bottom plate, compressing the one of the springs in each channel. In a most preferred embodiment, there is a top circular plate above the binding plate, and the binding plate has a circular seat for an annular L-section bushing which seats in the seat, and mates with the top circular plate. This L-section bushing is preferably plastic, and serves multiple purposes. It not only protects against metal to metal contact where the top circular plate is metal, but also seals the assembly against snow, ice and water, even if the top circular plate is made of plastic. Further, the L-section bushing removes or limits play between the top circular plate and the binding plate, which can affect performance especially responsiveness of the board. In another embodiment, a Y-shaped channel having a single spring positioned therein is used instead of a second set of springs.

### BACKGROUND OF THE INVENTION

1. Field of the Invention

The present invention relates to a binding for a sports board that is rotatable during use, and more particularly to sports boards' bindings such as for a snow board or wakeboard which bindings that are rotatable during use and biased to a preset position.

2. Description of the Related Art

Snow boarding has grown tremendously in popularity over the last two decades. Part of its growth has resulted in a variety of snow board competitions, such as freestyle, jumping, racing, and other competitions. Unlike snow skiing where the skier's feet are separately movable because there is a ski for each foot, the snow boarder's feet are secured in bindings that are fixed to one board. The rear or back foot is usually at an angle of about ninety degrees to the length of the board (front to rear axis of the board). The front or lead foot is usually at an angle of about forty five to sixty degrees to the length of the board. Typically, neither binding is rotatable. One can change the mounting angle of the bindings, but once changed, they are fixed during use.

Some snow board bindings have been developed that allow for adjustability of the angle during use. For example, in U.S. Pat. No. 5,855,390 to Hassell the binding may rotate about a horizontal axis, and is biased by one large torsion spring toward the parallel position on the board.

U.S. Pat. No. 5,577,755 to Metzger discloses a snowboard binding that is rotationally adjustable and may have a very small amount of rotational movement during use, and if it does, that would only be in an extreme situation due to springs providing a large spring force.

U.S. Pat. No. 5,236,216 to Ratzek describes a plate binding with a circular top piece that is adjustable in various elongate holes formed therein. Adjustment is performed prior to snowboarding and is fixed during snowboarding.

U.S. Pat. No. 4,964,649 to Chamberlain describes a plate binding which is adjustable during use and can return to the original setting, using an elastomeric device. A first round plate is attached to a board. A second plate rotatably is fitted over the first plate. The lower plate has a channel adjacent its periphery, and has a plurality of springs (four) disposed in the annular channel. Two pairs of bosses are positioned at 180° from each other and extend from second plate, while two pairs of stops extend from the first plate at 180° from each other, and 90° from the bosses. An optional adjustment plate having holes therein is on top of the second plate to permit linear and angular adjustments of the fixed position of the binding plate. Chamberlain's springs extend and bend almost 90° each. The springs may be attached at there ends or be floating. The springs in such a configuration will wear quickly, and appear to have uneven forces due to the bending. In addition, the structure must be well sealed or resistant to the elements, as it will be subject to water, ice, snow, freezing and thawing cycles, and large temperature variations causing expansion and contraction issues. The structure uses ball bearings but only between the rotational parts of the upper and lower circular plates, and provides little seal and little measures against rubbing, excessive play, and wear. Chamberlain does not give sufficient criteria for the springs to avoid undue experimentation by those who try to implement its teachings. The structure appears very complex and expensive to manufacture.

Sabol, U.S. Published Application No. 2003/0230870, published Dec. 18, 2003 discloses a bottom plate with an arcuate groove receives a part from a second annular plate 35 having a post for fitting in the groove. A T-handled screw is spring biased downward into a selected hole to adjust the rotational position of the binding.

Fiebing, U.S. Published Application No. 2003/0146588, published Aug. 7, 2003 discloses a canted and swivelable binding.

U.S. Pat. No. 5,028,068 to Donovan discloses a snowboard binding involving rotation.

In the last twenty years kinetics, the study of the energy created by motion, has resulted in many huge advancements in sports. These are most obvious in ice-skating and swimming, where the slightest change in position of the feet (skating) or hands (swimming) enables more complex tricks, better times, and huge energy conservation. These same basic principals are the foundation of the improved binding.

What is needed is a snow board or wakeboard binding that can be rotated in a horizontal plane by a user on the fly for doing tricks and special maneuvers, yet is readily able to find the preset or original or home position.

### SUMMARY OF THE INVENTION

The invention is a snow board binding or a wakeboard binding which in one embodiment is rotatable in a horizontal plane along the board, and in a preferred embodiment is biased to a preset or original or home position. The biasing force is adjustable and generally is set in a range that allows movement during actual boarding use, requiring more than casual effort to change the angle but less than extreme effort to change the angle.

Preferably, the structure is relatively simple. In one embodiment, there are two arcuate channels in the bottom of a binding plate. In each channel there is a spring assembly having a central block fixed to a circular bottom plate. The block has a spring on each side, which springs are also in the channel. As a user rotates his foot in the binding, the binding plate rotates on the circular bottom plate, compressing the one of the springs in each channel.

In a most preferred embodiment, there is a top circular plate above the binding plate, and the binding plate has a circular seat for an annular L-section bushing which seats in the seat, and mates with the top circular plate. This L-section bushing is preferably plastic, and serves multiple purposes. It not only protects against metal to metal contact where the top circular plate is metal, but also seals the assembly against snow, ice and water, even if the top circular plate is made of plastic. Further, the L-section bushing removes or limits play between the top circular plate and the binding plate, which can affect performance especially responsiveness of the board.

In a further embodiment of the invention, instead of a second channel with springs, a Y-shaped channel having a single spring positioned therein and connected at one to the bottom circular plate and at the other end to the binding plate serves to improve responsiveness and return of the binding plate to its home position. The sides of the Y-channel are close to the spring resulting in a quick and smooth return action with very little end vibrational action.

The home position may be adjustable, by rotating the top circular plate (held in place e.g., by a standard three or four hole screw pattern with screws fixed to the board passing through the top circular plate, the binding plate and the bottom circular plate). The bottom circular plate could be attached to the board, so that the binding moves on the bottom circular plate which may also be annular, and may also have a plastic annular bushing between it and the binding plate. However, the position of the top circular plate is adjustable by pulling up and rotating during nonuse, then re-seating the plate which has many projections depending downwardly to fit in holes in the bottom circular plate to prevent rotation. This could also be accomplished through many other existing and new systems of teeth and mating holes to lock the parts in place. Restrictions on the number of teeth and holes are the size of central circular hole 16 and the outer radius of bearing surface 32.

In a further preferred embodiment, the spring force or resiliency force is adjustable.

### BRIEF DESCRIPTION OF THE DRAWINGS

FIG. 1 is a front perspective view of a snowboard with two bindings in accordance with a first embodiment of the invention;

FIG. 2 is an exploded front perspective view of one of the two bindings of FIG. 1;

FIG. 3A is a bottom view of a binding plate of the binding of FIG. 2 with the binding in a neutral position with equal compressive force on two springs of a spring assembly;

FIG. 3B is a view similar to FIG. 3A with the binding rotated counterclockwise and one of the springs (the clockwise spring, on the right) being in more compression than the neutral position of FIG. 3A and the other of the springs (the counterclockwise spring, on the left) being in less compression than the neutral position;

FIG. 3C is a view similar to FIG. 3A with the binding rotated clockwise and the clockwise spring on the left being in less compression than the neutral position of FIG. 3A and the counterclockwise spring on the right being in more compression than the neutral position, and also showing a second spring assembly subject to the same force arrangement but the counterclockwise spring is on the left and the clockwise spring is on the right;

FIG. 4A is a bottom view of the bottom of the binding plate and a bottom disk with the binding in assembled form, showing a second embodiment of the invention where there is a spring located in a Y-shaped channel on one side of the disk instead of the second spring assembly;

FIG. 4B is a vertical sectional view taken along the line 4B-4B of FIG. 4A of the portion of the binding plate assembly of FIG. 4A, this sectional structure preferably being the same for both the first and second embodiments;

FIG. 5 is an enlarged bottom view of the embodiment of FIG. 4A with the bottom disk removed;

FIG. 6 is a partial bottom perspective and enlarged view of a portion of the bottom plate of FIG. 4A showing, partially in phantom, an arcuate channel in which one spring assembly is to be located, without showing other details; and

FIG. 7 is an enlarged view of a modification of a central body in a spring assembly of the binding of FIGS. 3A-3C or of the binding of FIGS. 4A and 5.

### DESCRIPTION OF THE PREFERRED EMBODIMENT(S)

With reference to the perspective view of a snowboard 2 having a front foot binding assembly 4 (left foot in the position shown, but it can be the right foot) and a rear foot binding assembly 6 (right foot in the position shown).

A snow boarder will put his or her feet having boots thereon into the binding assemblies 4, 6 and close straps 8, 10 for a snug secure fit. The rear binding assembly has two straps also.

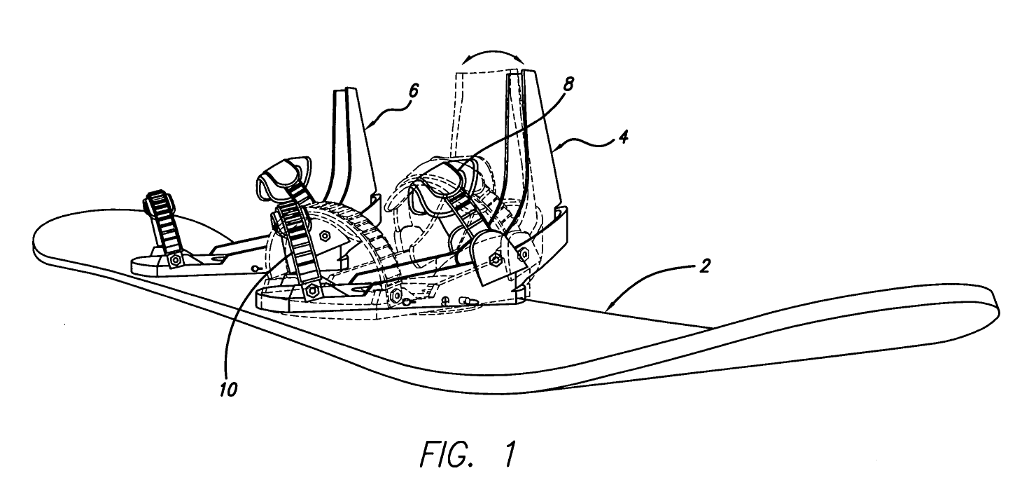

The more rigid the connection from the board to the binding to the user's feet, the more responsive the board will be to the user's motion. In one embodiment of the invention, the front binding assembly is rotatable clockwise or counterclockwise about a vertical axis through the binding or bottom plate. FIG. 1 further shows binding assembly 4 in phantom after it has rotated to the left with respect to a horizontal axis running the length of binding plate 4 (toe end of binding rotated out of the page). As explained in detail below, in a preferred embodiment of the invention, the binding assembly may be rotated “on the fly,” i.e., during use even while the user is snowboarding downhill.

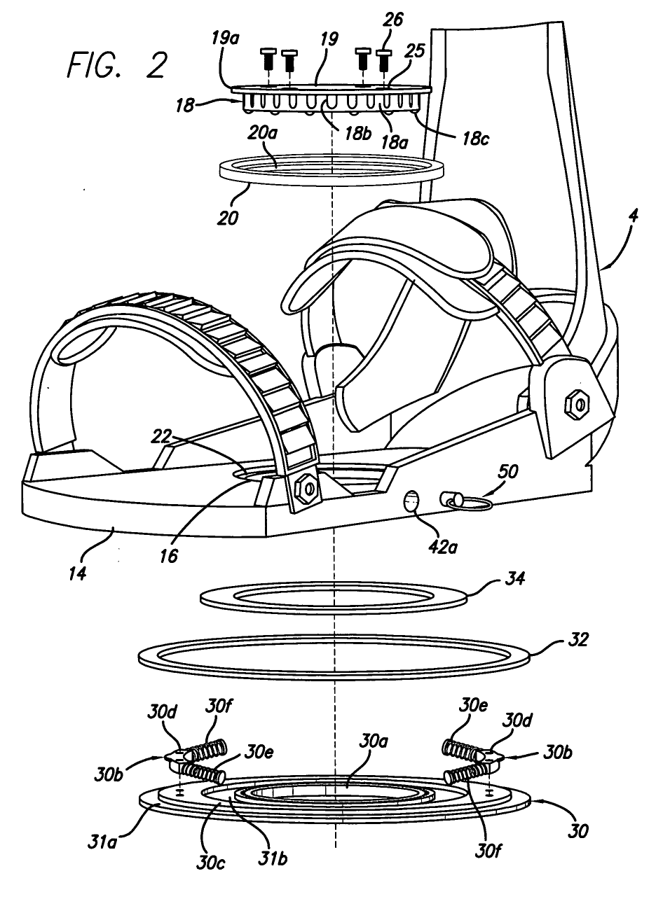

As shown in the exploded view of FIG. 2, the binding assembly 4 includes an essentially standard binding plate 14 having a circular hole 16 therethrough. An upper plate 18 is circular with a disk-shaped top 19 having an overhanging lip 19a, and a round partial cylinder 18a at a lower portion of upper plate 18. Plate 18 and lower cylinder portion Upper plate 18 sits on an annular upper bushing 20 such that lip 19a sits in seat 20a. Bushing 20 may be made of a durable, strong yet low friction plastic such as a nylon polymer. In turn, the bushing 20 sits in an annular ledge 22 formed around the inner periphery of the hole 16.

Upper plate 18 may be metal, similar to the bottom plate 14 which has generally heretofore been made of metal. However, it is preferable for the upper plate 18 to be made of a high strength and durability plastic so that it may be easily molded. A plastic upper plate 18 facilitates forming multiple notches or recesses 18b in a periphery of cylindrical portion 18a. These notches, preferably there are many e.g., about twenty four (24) evenly spaced at fifteen degrees (15°), will be explained later. In addition, forming the upper plate 18 of plastic facilitates making the upper plate in one unitary piece, although it can always be formed of multiple pieces epoxied, sonic welded, or otherwise permanently and rigidly affixed together, or formed in one piece of metal, e.g., aluminum or an aluminum alloy. Upper plate 18 also has nubs or protrusions 18c, and preferably there are several extending from the bottom of the cylinder 18a. In a preferred embodiment, there are ten (10) protrusions 18c evenly spaced at thirty six degrees (36°). The purpose of the protrusions 18c will be described below.

The upper plate 18 is fixed to the board to hold the assembly together. Typically, as shown in some of the patents and publications discussed in the background section, there are four screw holes 25 in a top plate and four screws 26 to fix it to the board. However, other screw patterns include three screws and three holes. Other ways to fix the top plate to the board may also suffice.

Under the base plate 14, there is a bottom disk or bottom plate 30, which sits on the board's top surface, an outer gasket 32 and an inner gasket 34. Bottom disk 30 preferably has a central aperture 30a although it need not have one. It is preferably is not fixed to the board for adjustability as described later, although in another embodiment it could be fixed thereto, e.g., by screws.

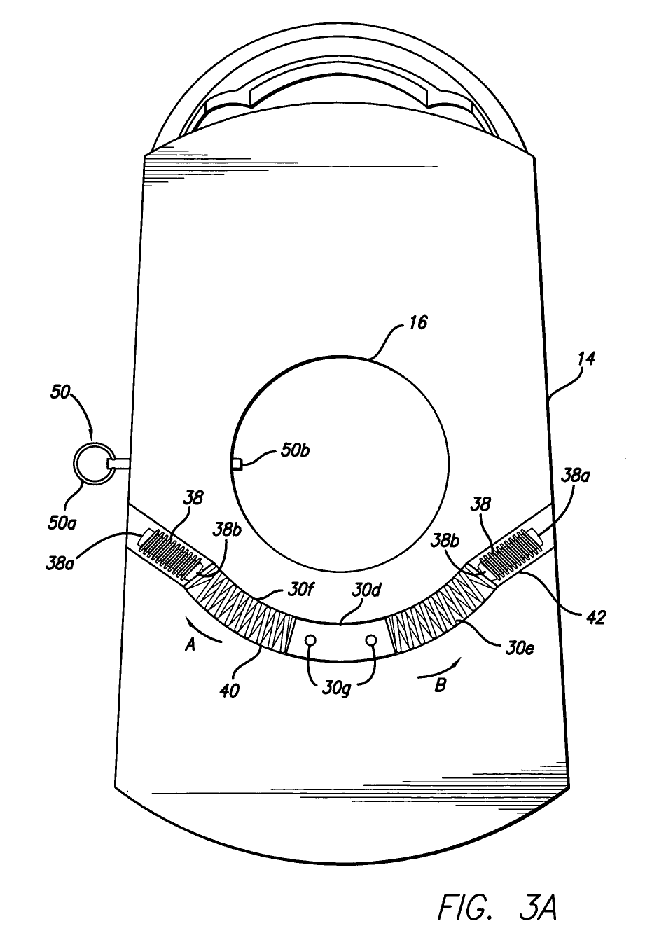

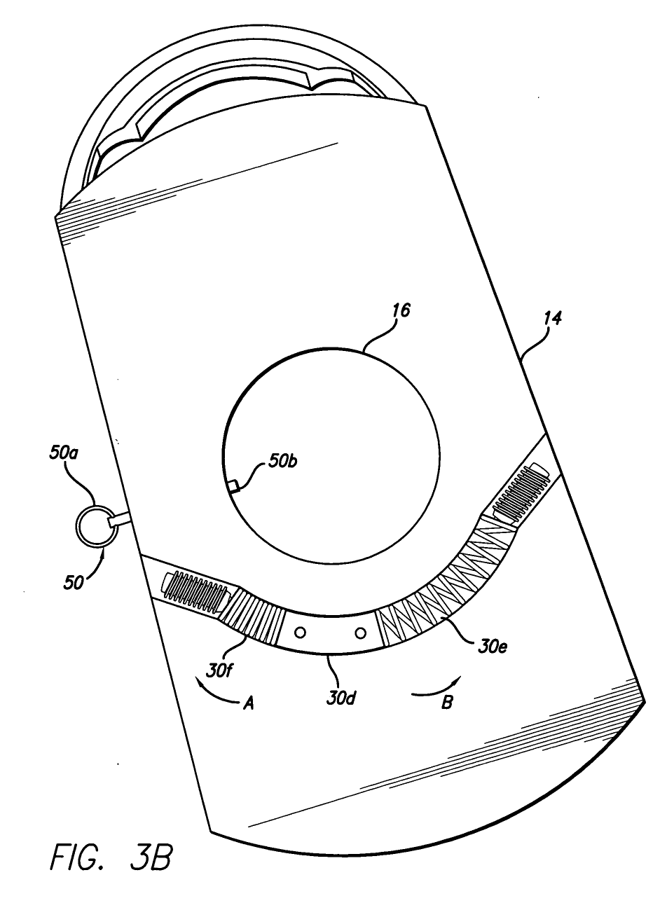

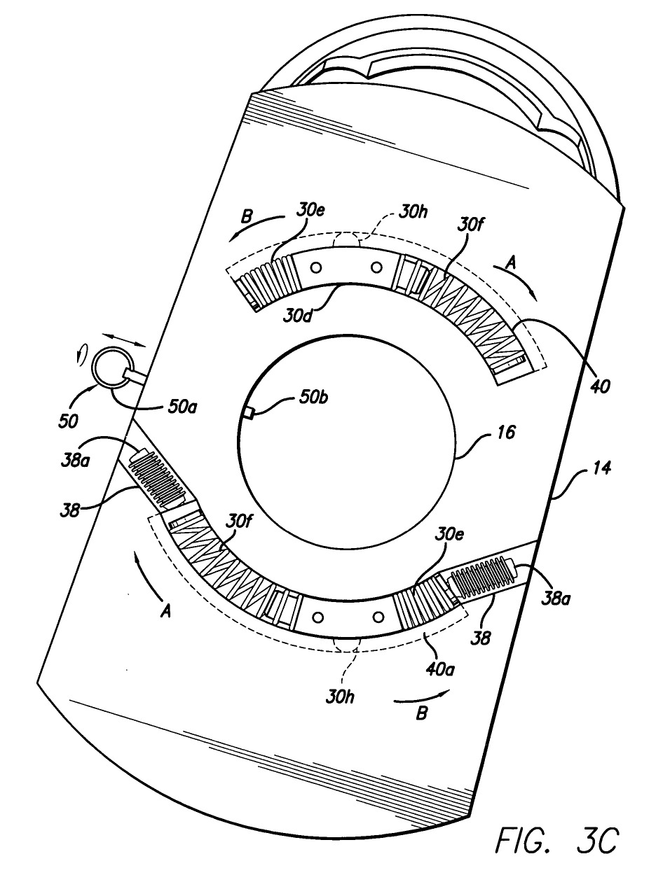

There are two spring assemblies 30b that are fixed to the disk 30, e.g., by screws (not shown) passing through holes 30g (FIG. 3A), e.g., on a raised annular portion 30c of the disk. Each spring assembly has a central body 30d which has one spring 30e fixed to one side of the body and another spring 30f fixed to the other side of the body. The springs may be “fixed” by simply fitting snugly over a projection on the end of the body 30d, and/or by putting the end of the spring in a hole or through a loop in the body. The springs may also “float.” As shown in FIG. 7, a body 30d has an enlarged projection 130 which snugly fits the spring's end, which greatly reduces wear. More specifically, the projection 130 is sized in length and thickness so that when the spring is compressed, many or all (preferably at least about one half) of the coils fit over the projection and the spring as a whole has limited bending where the projection 130 is located so that the spring has limited rub against the sides of the channel and limited “crushing” effect if the rider turns the binding plate with maximum force. This helps keep the spring in shape and minimizes wear. It is also noted that the projection 130, if long enough in relation to the size of the channel, can function as a stopper limiting maximum rotation of the binding plate, when the projection hits the screw 38, if the projection is as long or longer than the maximum compression of the spring. It is also noted that the ends of the screws 38 may be made with similar projections.

The springs may be typical springs with round cross sections or springs with relatively thin rectangular or washer-like cross sections. The springs preferably have flat or flattened ends, or have a washer fixed e.g., by welding, to their ends, to help avoid wear when in use and abutting the ends of the stoppers. The springs may also be replaced with other resilient members, e.g., rubber bodies.

The outer gasket 32 sits in an outer annular seat or recess 31a on the bottom disk 30 and the inner gasket 34 sits in an inner annular seat or recess 31b. The thickness of the gaskets 32, 34 is preferably slightly greater than the height of the raised annular portion 30c, so that the gaskets will support the binding base plate 14.

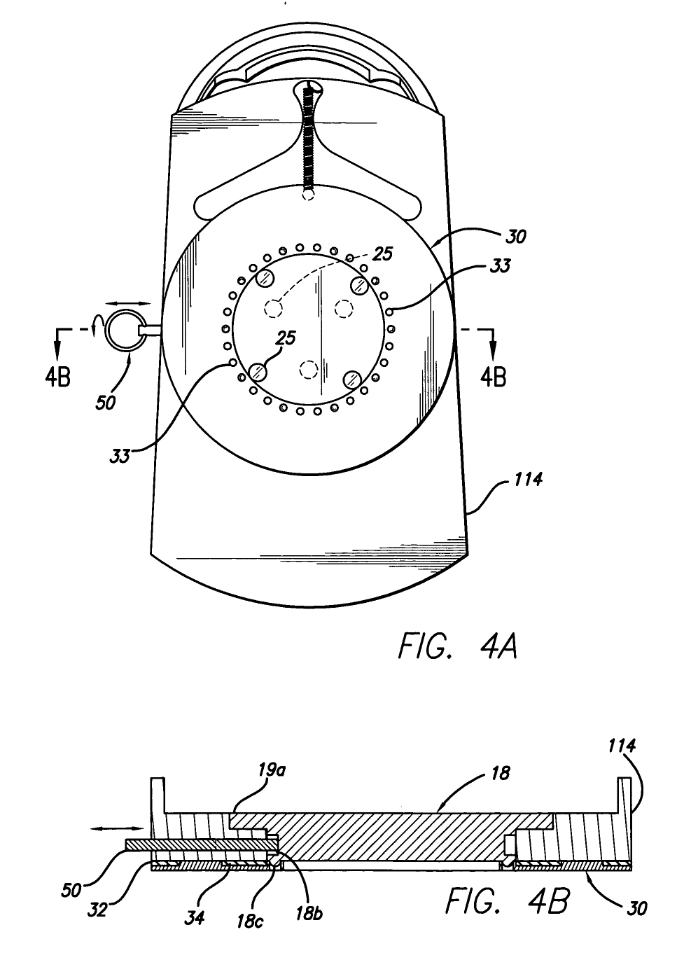

The bottom disk 30 has at its inner periphery a number of evenly spaced recesses or holes 33, e.g., thirty (30) as shown in the bottom view of FIG. 4A. The projections 18c on the underside of the top plate or disk 18 fit in the recesses or holes 33. In the preferred embodiment there are fewer recesses or holes 33 than projections, but the number of projections can be the same as the number of holes. The projections must be strong enough in the aggregate so that when in the holes during use of the board or not, they will hold the bottom disk in place. During nonuse, the home or neutral rotational position of the base plate 14 may be adjusted from e.g., forty five degrees (45°) for the front foot binding up or down as desired by unscrewing the top plate 18 and pulling up enough to remove the projections from the holes 33, then rotating the base plate in the desired direction of increased or decreased angle, then re-seating the projections into the holes 33. If there are thirty (30) evenly spaced holes 33, then there are positions of rotational adjustment every twelve degrees (12°). The hole pattern may be increased, decreased or nonevenly spaced as desired. Any suitable projection and recess or the like locking system may be used.

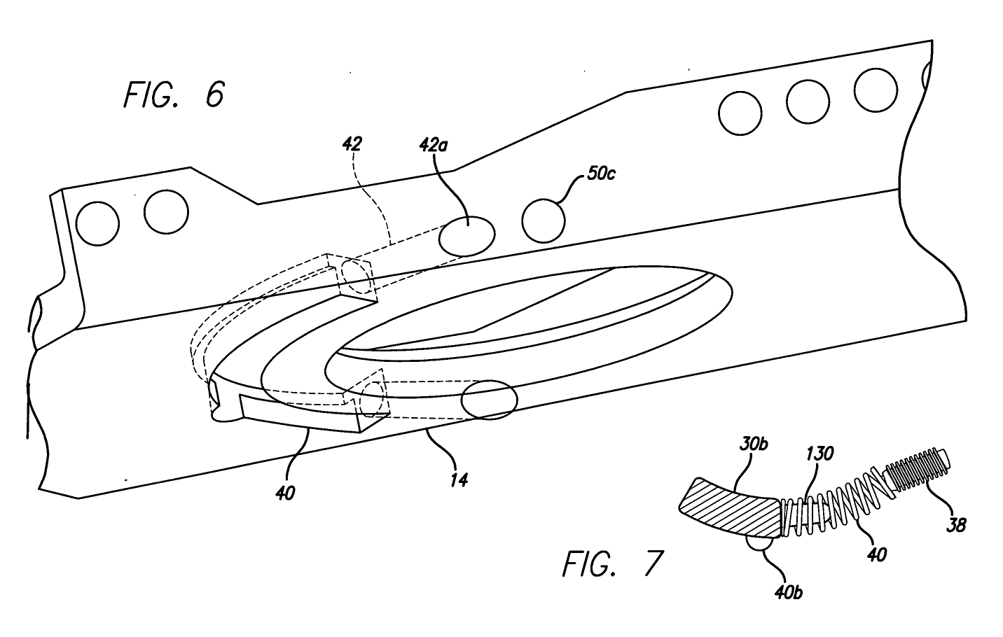

As shown in FIG. 3A, the-underside of base plate 14 is flat, with its aperture 16 and an arcuate channel 40 for holding one spring assembly. Another identical but mirror image channel for holding the other spring assembly is located on the opposite side of the aperture 16. The spring assembly 30b is disposed inside channel 40. Stopper screws 38 are located in a continuation section 42 of channel 40 when extends to the exterior of the side of base plate 14. The continuation section 42 is preferably formed as a threaded tunnel (see FIG. 6) with a hole 42a at the side of the base plate. Stopper screws 38 have an outer end 38a having a slot for a flat head or X-slot for a Phillips head screwdriver for adjustability of the initial compression setting (or tension setting) on springs 30e, 30f. Most preferably, the screw has a hex head to allow for smallest possible size head. The hex head also enables more control of the amount of rotation in each direction in relation to a Phillips head or flat head. For example, the binding plate will rotate the most, e.g., thirty degrees in each direction with the screws 38 pulled out allowing for full rotation. When screws 38 are both pushed in all the way that allows for the least rotation, preferably only rotate ten degrees in each directon. Screws 38 effectively shorten the length of the channel and can be used to limit rotation in any or all direction, or may not be in use at all. They are designed to typically be set once, or once in awhile, and are very tight and hard to turn so they will not move during use. This is similar to the adjustment which allows the pressure setting in a typical ski binding. The screw stoppers 38 allow the bias of the springs on the base plate to be adjusted from balanced compression on springs 30e, 30f to more compression on springs 30e or more on springs 30f.

The ends 38b of the screw stoppers preferably have a projection that fit in the ends of the springs 30e, 30f, and may fit snugly, float or be fixed thereto by fitting the spring ends in a loop or hole on end 38b. As one screw 38 is being pushed in and out at a time, its position is constantly changing in relation to the center line of the channel. To be connected to the spring without causing the system to bind would be difficult and require that the end could move in relation to the spring end, or be a worm drive 38 rather than a direct drive as represented.

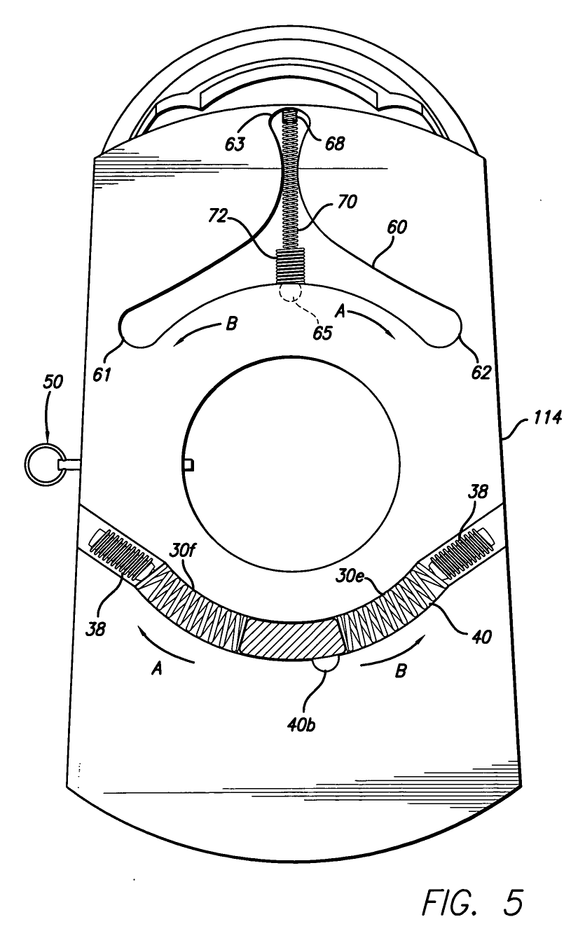

To help hold the bottom disk 30 and inner and outer gaskets 32, 34 of the binding assembly together with the base plate 14 when making adjustments that do not require taking the bottom disk off, body 30d has a tongue 30h, that slides in a groove 40a that communicates with the channel 40. Tongue 30h enters the groove via an offset recess 40b in channel 40 (see FIG. 5). This construction helps to hold the springs and bottom plate in place when the binding plate is loosened and/or removed from the board.

Basic operation of the binding will now be described with reference to FIGS. 3A, 3B and 3C. As shown in FIG. 3A, the springs 30e and 30f are in equal states of compression (or the springs can have an initial compression or tension if the ends are fixed). During snowboarding, the user as desired will rotate his or her foot in the direction of arrow A (clockwise) or arrow B (counterclockwise). When rotating clockwise, spring 30f undergoes compression (FIG. 3B). Spring 30e will undergo extension if fixed (as shown). When rotating counterclockwise, spring 30e undergoes compression (FIG. 3C). Spring 30f will undergo extension if fixed (as shown).

When the user desires to return his or her foot to the home position, the user relaxes the pressure and the springs bias the user's foot back to the home or neutral position. If there are two identical channels and two spring assemblies (shown in FIG. 3C), both assemblies work in the same way. Two assemblies allow for symmetry of forces, however, one assembly may be used. The springs need not be adjustable, however, it is preferred that screw stoppers or other adjustment mechanism be provided. If two spring assemblies are used, it is also an option to have only one assembly be adjustable or to have both assemblies adjustable.

As shown in FIGS. 3A-3C, there is a locking pin 50 that enables the user to lock the binding against rotation, even while still wearing the bindings. The pin passes through an opening 50c (FIG. 6) in the base plate. The user grabs loop 50a, designed to be handled even with a ski glove, and turns it. The pin has an inner end 50b, which depending on how the user moves the handle 50a, may be in the locking position (projecting into the side of the hole 16 as shown in FIGS. 3A-3C), where it will mate with one of the recesses 18b on the side of top plate 18, thereby holding the binding plate from rotation. The recesses 18b are provided all around the top plate to allow for various available “on the fly” locking positions for comfort in any terrain. The number of available positions is limited by the diameter of top plate 18 and the diameter of the lock end or nose 50b. The smaller end 50b is and the larger the diameter of top plate 18, the more locking positions available. One of the available positions is top dead center or the home position. The rider is able to choose his or her preferred position as the return position of the binding plate. The numerous evenly spaced holes make it so that the orientation of installation of the top plate is not a factor. The pin may be a spring loaded pin or a threaded pin, or other suitable locking device. Typically such pins will lock or unlock with a one quarter turn.

A second embodiment of the invention will be described with reference to FIGS. 4A and 5. In this embodiment, there is a base plate 114 which is the same as base plate 14, except that it has a Y-shaped channel 60 in its underside, instead of one of the channels 40 at the end of the binding or base plate 114 where the user's heel is placed. Y-channel 60 has a stem 63 and branches 61, 62. A spring 70 is attached at one end (e.g., by passing the end of the spring through a loop or hook) to a first post 65 on the bottom disk or plate 30, and attached in the same or a similar way at the other end to a second post or ring 68 fixed to the base plate 114. Spring 70 is in tension when the binding plate is rotated in either direction A (clockwise in FIG. 5) or direction B (counterclockwise in FIG. 5). The tension on the spring 70 serves to bias the plate back to the neutral or starting position. End 72 of the spring is shown enlarged to better show and/or emphasize its connection to the post, but typically would not be enlarged. In this embodiment, it is desirable for the Y-channel shape to be such that the spring is tight against the stem of the channel at all times (the channel stem cross-section is substantially the same size as the spring cross-section, e.g. about the same radius for a press or snug fit), which helps provide a smooth biasing force back to the center or home position of the spring. Such a structure may also minimize wear.

Variations of the above may include providing a front foot binding with one set of springs (one channel, or two channels, but only with one set of springs as an option to having two sets of springs), and a rear foot binding having a Y-channel spring embodiment as shown in FIGS. 4A and 5 for a faster response. In other words, a system with a faster response on one binding may be desirable. Faster response on one binding may also be achieved by using springs, but setting the adjustments so that there is more initial compression on the springs, and/or using stronger springs in the one binding than the other. Since snowboarding is bi-directional one often flips the position of the feet while traveling down the mountain. This is called riding goofy or fakey. The flip puts the front foot where the back would normally be and vice versa allowing one to make his or her way down the mountain in any stance. Typically the rider's feet have been limited in movement causing one way of travel to be more desirable than the other due to lack of ability to reposition the rider's body due to the fact that the rider's feet are being held in a fixed position. The rotation of this binding solves this problem and makes riding fakey much more comfortable through repositioning of the feet.

Preferably, the springs are attached such that they are secure, yet may readily be removed and reattached with pliers.

The device may be made of metal, such as stainless steel, aluminum, an aluminum alloy or any other composition of similar or higher tensile strength, and rigidity. Alternatively, the various elements of the device may be made of plastics, and/or similar materials, e.g., polycarbonates, polycarbonate and glass blends, carbon blends, thermoplastics and thermosetting plastics. In addition, elements of the device may be made of such plastics or similar materials and have an inlay of metal or carbon. Preferably, the entire device would be made of a strong thermoset or thermoplastic.

For some elements of the device, it may be desireable to use metal, such as stainless steel, for strength, if the element is very thin or particularly vulnerable to high forces, e.g., the thin bottom plate to which the stoppers are attached. In addition, the L-shaped gasket or bushing, and the other bushings or gaskets may be made of Delrin® or Nylon, or other low friction or “frictionless” plastic. It is also noted that one or more, or all the bushings may be integral or unitary with one of the pieces in which they sit or mate, e.g., by gluing or otherwise affixing them thereto, e.g., the L-shaped bushing may be glued to the base plate or the top plate.

In a preferred embodiment, the base plate may have a beveled bottom surface, such as a one half degree or other small taper toward the outside to help ensure that the bottom surface of the base plate does not rub on the board surface when rotating the base plate. In addition, to help reduce wear, the springs and/or channels may be coated e.g., with Teflon® or other low friction material such as oil or wax.

Preferably, the Y-channel has a small cant outward in the downward direction when the base plate is on the board, e.g., three degrees.

It is noted that in a preferred embodiment, the profile or thickness of the binding is intended to be very close to or the same as a standard binding. It is also intended that the binding be relatively lightweight, easily manufactured and easily assembled and disassembled, and that the binding have good shear strength and be subject to limited vibration. It is also desirable that the binding be well sealed from the elements, to minimize or avoid problems caused by snow, ice, water and dirt.

It is also noted that in addition to or in place of springs, other compression, tension, and/or elastomer members may be used, such as a rubber body, or the like.

The tension loaded, functional binding is movable (or swivelable) to whatever degree is deemed appropriate for final the product (preferably between about twenty and thirty degrees in each direction). The binding has a spring loading mechanism (e.g., pin 50 and the notches or recesses in the top plate) allowing the rider to easily (at any point on the hill with a gloved hand) stop the binding from swiveling by locking it into place.

The binding is also preferably adjustable in two ways. The hole pattern in the bottom plate allows for initial stance adjustment by adjusting the rotational position of the top plate. In addition, as the rider moves, the device is making finite adjustments at all times, as well as giving a rider the ability to make his or her own finite adjustments by moving his or her feet as desired. A spring loaded mechanism 50 allows the rider the option of locking the binding in the initial position, or any of various other positions within the allowed degree of rotational adjustment of the binding.

The device obeys and applies the Physical Laws of Motion, Mechanics, and Kinetics (specifically Newton's Laws of Motion).

The movement of the feet associated with board sports, especially surfing, allows the rider to more easily accomplish constant perfect balance in a continually changing environment. Moreover, using the device, the rider is able to make tighter, faster turns (even in deep tight moguls) and at high speeds. This is very important for riders who like to ride a longer board for speed, but also like to conquer steep, bumpy terrain that has been carved out by skiers.

The device also achieves substantial relief on the ankles, knees, and hips while riding as well as well as while skating (sliding the board) though a lift line, and while riding in a ski lift chair. The device also helps eliminate toe drag (toe portion of the boot dragging in the snow while leaning in a turn), which allows for further leaning into turns and/or faster smoother turns. Toe drag is a problem that occurs for many or most adult snowboarders.

The device also improves safety, in that the movement allows the rider to be constantly adjusting stance for changing conditions to enhance safety and minimize risk of injury.

The springs in the channel cause it to have a constant tendency back to center. This is to draw the board, and feet, back to initial positioning while in the air during tricks and jumps, as well as providing added maneuverability while executing tight turns. The quick response of the springs is much faster and more accurate than any human response.

The springs act as shock absorbers on the ankles, legs, knees, hips, and lower back as the rider torques their body to maneuver themselves down the mountain.

The lock is to provide the rider with the ability to, at any time desired, and also in the event of malfunction, lock the binding in the center position, or any other position within the allowed rotation. This allows the rider to use the binding in the same way as any conventional binding.

A. Newton's Second Law States: FORCE=(MASS)(acceleration).

The force in the equation is total force, and takes into account all outside forces, such as centrifugal, centripetal, gravitational, inertial, and otherwise, on an object in motion. In analyzing the device, the mass of the object is constant while the acceleration is fluctuating. As the rider accelerates, the total force increases, and as the rider decelerates, the total force acting on the object from outside decreases.

B. Newton's Third Law of Motion States that, to Counter Any Force, an Equal but Opposing Force is Required.

If the outside forces are increasing with acceleration, then the required force to counter those outside forces is also increasing. Therefore, in a standing still position, the device will rotate with less force from the rider, however, while accelerating the required force input by the rider is much greater. Although riders are often at a roughly constant speed when moving straight they are accelerating through turns and as they swerve back and forth on the snowboard. Eventually, depending on the degree of declination of the terrain, and directly related to the initial (resting) compression strength of the channel springs, riders reach outside forces that are too large for typical riders to overcome on their own, and thus the rider is no longer able to turn the binding.

The spring force is an important factor in the proper use of the binding. If it is too great, the user will not be able to rotate foot position very much. If too loose, the user will have a hard time controlling the foot position, and the binding will not readily return to the neutral position. Potentially complicating matters are the limited space for the springs, the variety of rider sizes and strengths, the elements (snow, water, ice, and dirt), and limited rotational distance of the channel.

Ideally, the channel should be as far away from the central aperture as possible, to provide a channel having a maximum length. A relatively small central hole, which creates less resistance to rotating the binding, would limit the range of spring displacement and reduce the number of rotational adjustment positions given the same spacing of the nubs or protrusions. A slightly larger hole, or hub, would create slightly more resistance, create more rotational adjustment positions, and allow for more spring displacement.

The typical force ranges of the springs are set so that the amount of displacement of the springs during normal use will be no more than the maximum compression of the spring, and the minimum to compress the spring is more than a trivial amount. The desired spring constant “k” may be determined using the following equation:

F=kx, where “x” is the displacement of the spring, “k” is the spring constant, and “F” is the force applied to the spring. For example, if k is equal to 23 lbs/inch initial, for a 1″ displacement along the channel, F equals 23 lbf. At x is 0.75″, F equals about 18 lbf. In reality, due to nonlinearities, friction and other irregularities, at different deflections, k may vary. If k is 28 lbs/inch at x is 0.75″, then F equals about 21 lbf.

The preferred ranges of k may be broadly delineated, e.g., one range may be used for riders over one weight such as over two-hundred pounds and another range for riders under that weight, e.g., under two-hundred pounds. Empirical evidence has shown that even a beginner rider (for snowboarding) weighing about 115 lbs is easily able to use the same bindings that an experienced or expert rider who ranges from 190 lbs to 200 lbs may use. Empirical evidence also showed that the springs wear out faster for a heavier, experienced rider. However, by adding the control piece discussed above for taking up the spring during compression, wear has been reduced greatly.

It has also been found that a person snowboarding in open steep powder may want less resistance than a person in a defined narrow slope or on a groomed slope.

Although initial resistance differences are very noticeable when at a standstill or low speed, the differences have been found to become almost negligible once a rider is in motion. For example, a spring with 15 lbf/in may feel very much the same as a spring with 25 lbf/in once the rider is in motion.

Suitable springs may be obtained from Century Spring Corp. of Los Angeles, Calif. One example of a suitable spring is part #71187 at Century Spring Corp., which has a spring constant of 23 lbs/in. Such a spring accommodates a large range of rider weights and skill levels. The spring constant k may vary greatly depending on the desired range of deflection of the spring. By way of example, it is preferred that the spring constant k be in a range of from 17 lbf/in to 40 lbf/in, inclusive. Also by way of example, a preferred maximum deflection of the spring is from 0.33″ to about 0.75″ and more preferably around 0.60″ to 0.70″, most preferably around 0.66″.

Other ranges for k may include 2 lbf/in to 40 lbf/in and more preferred is 10 lbf/in to 25 lbf/in and most preferred is 18 lbf/in to 22 lbf/in or 23 lbf/in for the typical teenage or adult male, the ranges will be smaller for children and females, and of course other values may work as well.

When the binding is used for wakeboarding, because gravity is perpendicular to the direction of motion, as opposed to on a hill where gravity is not perpendicular to the direction of motion and thus assists in the motion, and there is more drag yet one is pulled by a boat in wakeboarding, the spring force would be expected to be set differently from snowboarding. Preferably, in wakeboarding bindings, the spring force and thus the spring constant should be significantly higher than in snowboarding.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A binding for a board, comprising:
a base plate having a top on which a user may place and fasten the user's foot and a bottom opposite the top;
a top round member for fixing the base plate to the board from the top of the base plate and having at least a portion extending through an aperture formed in the base plate from the top to the bottom thereof;
a bottom annular disk member;
an upper bushing between the top round member and base plate for rotation of the base plate with respect to the top round member;
a lower bushing between the disk member and bottom of the base plate; and
a biasing device fixed with respect to the disk member and responsive to rotation of the base plate for biasing the base plate to a predetermined position.

2. The binding of claim 1 wherein at least one channel is formed in the bottom of the base plate and the biasing device is disposed therein.

3. The binding of claim 1 wherein the upper bushing has an L-shaped cross section.

4. The binding of claim 3 wherein the upper bushing is annular.

5. The binding of claim 1 wherein there are two arcuate channels formed in the bottom of the base plate on opposite sides of the aperture formed through the base plate.

6. The binding of claim 1 wherein the biasing device comprises springs.

7. The binding of claim 1 wherein the top round member has a T-shaped cross section defined by an upper lip of radial size greater than a remainder of the top round member, and the base plate has an annular recess formed in the top thereof for mating with the upper lip of the top round member, with the upper bushing fitted therebetween.

8. The binding of claim 1, wherein the binding plate has an arcuate channel extending circumferentially part way around one side of the aperture and a Y-shaped channel disposed on the other side of the aperture, and there are at least two biasing devices, one of the biasing devices being disposed in the Y-shaped channel and one disposed in the arcuate channel.

9. The binding of claim 8 wherein the biasing devices are springs.

10. The binding of claim 9 wherein the Y-shaped channel has its stem disposed radially remote and in a radial direction with respect to the aperture, and one of the springs is disposed with a first end in the stem and a second end connected to the disk member for movement back and forth in legs of the Y-shaped channel.

11. A binding for a board, comprising:
a base plate having a top on which a user may place and fasten the user's foot and a bottom opposite the top;
a top member for fixing the base plate to the board from the top of the base plate and having at least a portion extending through an aperture formed in the base plate from the top to the bottom thereof;
a bottom plate;
an upper bushing between the top member and base plate for rotation of the base plate with respect to the top member;
a lower bushing between the bottom plate and bottom of the base plate; and
a biasing device fixed with respect to the bottom plate and responsive to rotation of the base plate for biasing the base plate to a predetermined position.

12. The binding of claim 11 wherein at least one channel is formed in the bottom of the base plate and the biasing device is disposed therein.

13. The binding of claim 11 wherein the upper bushing has an L-shaped cross section.

14. The binding of claim 13 wherein the upper bushing is annular.

15. The binding of claim 11 wherein there are two arcuate channels formed in the bottom of the base plate on opposite sides of the aperture formed through the base plate.

16. The binding of claim 11 wherein the biasing device comprises springs.

17. The binding of claim 11 wherein the top round member has a T-shaped cross section defined by an upper lip of radial size greater than a remainder of the top round member, and the base plate has an annular recess formed in the top thereof for mating with the upper lip of the top round member, with the upper bushing fitted therebetween.

18. The binding of claim 11, wherein the binding plate has an arcuate channel extending circumferentially part way around one side of the aperture and a Y-shaped channel disposed on the other side of the aperture, and there are at least two biasing devices, one of the biasing devices being disposed in the Y-shaped channel and one disposed in the arcuate channel.

19. The binding of claim 18 wherein the biasing devices are springs.

20. The binding of claim 19 wherein the Y-shaped channel has its stem disposed radially remote and in a radial direction with respect to the aperture, and one of the springs is disposed with a first end in the stem and a second end connected to the disk member for movement back and forth in legs of the Y-shaped channel.
